(19) United States
(12) Patent Application Publication
(10) Pub. No.: US 2013/0330104 A1
(43) Pub. Date: Dec. 12, 2013

(54) PHOTORECEPTOR, IMAGE FORMING APPARATUS, PROCESS CARTRIDGE, AND IMAGE FORMING METHOD

(71) Applicants: Keisuke Shimoyama, Shizuoka (JP); Akihiro Sugino, Shizuoka (JP); Mitsuaki Hirose, Shizuoka (JP); Tomoharu Asano, Shizuoka (JP); Noboru Toriu, Shizuoka (JP); Hideo Nakamori, Shizuoka (JP)

(72) Inventors: Keisuke Shimoyama, Shizuoka (JP); Akihiro Sugino, Shizuoka (JP); Mitsuaki Hirose, Shizuoka (JP); Tomoharu Asano, Shizuoka (JP); Noboru Toriu, Shizuoka (JP); Hideo Nakamori, Shizuoka (JP)

(73) Assignee: RICOH COMPANY, LTD., Tokyo (JP)

(21) Appl. No.: 13/906,601

(22) Filed: May 31, 2013

(30) Foreign Application Priority Data
Jun. 6, 2012 (JP) 2012-129169

(51) Int. Cl. G03G 5/047

(52) U.S. Cl. CPC G03G 5/047
USPC 399/159; 430/69; 430/119.7

(57) ABSTRACT

A photoreceptor includes an electroconductive substrate, and a laminate structure formed of at least a charge generating layer and a charge transport layer and provided overlying the electroconductive substrate, wherein the charge transport layer contains a charge transport material, a compound represented by the following formula 1 and a compound represented by the following formula 2:

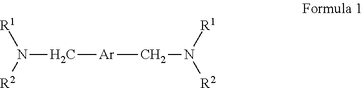

in the formula 1, R¹ and R² each independently represent substituted or non-substituted alkyl groups or aromatic hydrocarbon groups and one of R¹ and R² represents a substituted or non-substituted aromatic hydrocarbon group, R¹ and R² bonded to the same nitrogen atom may be bonded together to form a substituted or non-substituted nitrogen-containing heterocyclic group, and Ar represents a substituted or non-substituted hydrocarbon group;

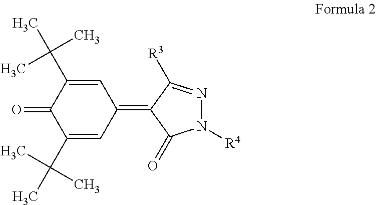

in the formula 2, R³ and R⁴ each independently represent substituted or non-substituted alkyl groups or aromatic hydrocarbon groups.

### CROSS-REFERENCE TO RELATED APPLICATIONS

This patent application is based on and claims priority pursuant to 35 U.S.C. §119 to Japanese Patent Application No. 2012-129169, filed on Jun. 6, 2012, in the Japan Patent Office, the entire disclosure of which is hereby incorporated by reference herein.

### BACKGROUND

1. Technical Field

The present invention relates to a photoreceptor, an image forming apparatus, a cartridge and an image forming method.

2. Background Art

An image is formed by subjecting an latent electrostatic image bearing member (photoreceptor) to steps such as a charging step, an exposure step, a development step and a transfer step in an image forming apparatus. At this time, a corona product generated in the charging step and residue toner that has not been transferred accumulate on the photoreceptor. Therefore, after the transfer step, the photoreceptor is subject to a cleaning step to remove the corona product and the residue.

For the cleaning step, a method is generally employed in which a rubber blade is pressed against the photoreceptor to remove residues on the surface of the photoreceptor. However, stress by the friction between the surface of the photoreceptor and the cleaning blade is high, so that the rubber blade and the surface layer of the photoreceptor wear down, leading to a decrease in the working life of the rubber blade and the photoreceptor. Accordingly, it is necessary to reduce degradation of the photoreceptor by friction. In attempts to improve the wear resistance of the photoreceptor, for example, a cross-linked surface layer (cross-linked resin layer) is formed on the surface of the photoreceptor.

Moreover, when the photoreceptor is charged and exposed repeatedly, the electrostatic stability deteriorates, such as an increase in exposed-area potential or a decrease in dark-area potential. This results in a problem in that the image density varies or an image blur occurs due to an oxidative gas and the like existing in the system.

In particular, photoreceptors having a cross-linked surface layer produce blurred images and have an increase of the residual potential in some cases when used repeatedly for a long time.

JP-2010-164639-A discloses a method in which a specific charge transport material and a specific additive are contained in a charge transport layer of a photoreceptor in order to stabilize the electrostatic characteristics thereof.

Although the photoreceptor in JP-2010-164639-A mentioned above is successful in some degree, its electrostatic characteristics are not sufficient.

### SUMMARY

The present invention provides a photoreceptor including an electroconductive substrate and a laminate structure formed of at least a charge generating layer and a charge transport layer provided overlying the electroconductive substrate, wherein the charge transport layer contains a charge transport material, a compound represented by the following formula 1, and a compound represented by the following formula 2:

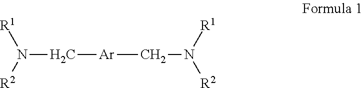

In the formula 1, R¹ and R² each independently represent substituted or non-substituted alkyl groups or aromatic hydrocarbon groups and one of R¹ and R² represents a substituted or non-substituted aromatic hydrocarbon group. R¹ and R² bonded to the same nitrogen atom may be bonded together to form a substituted or non-substituted nitrogen-containing heterocyclic group. Ar represents a substituted or non-substituted hydrocarbon group.

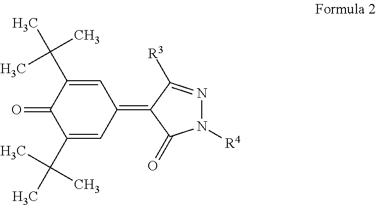

In the formula 2, R³ and R⁴ each independently represent substituted or non-substituted alkyl groups or aromatic hydrocarbon groups.

### BRIEF DESCRIPTION OF THE DRAWINGS

Various other objects, features, and attendant advantages of the present invention will be more fully appreciated as the same become better understood from the detailed description when considered in connection with the accompanying drawings, in which like reference characters designate like corresponding parts throughout and wherein:

FIG. 1 is a sectional view of one example of a layer configuration of a photoreceptor according to an embodiment of the present invention;

FIG. 2 is a cross sectional view of another example of a layer configuration of a photoreceptor according to an embodiment of the present invention;

FIG. 3 is a schematic diagram of one example of an image forming apparatus according to an embodiment of the present invention;

FIG. 4 is a schematic diagram of an example of a process cartridge according to an embodiment of the present invention; and

FIG. 5 is one example of the result of an X-ray diffraction spectrum measurement of titanyl phthalocyanine in the embodiment.

### DETAILED DESCRIPTION

The present invention is described in detail below with reference to the drawings.

Photoreceptor

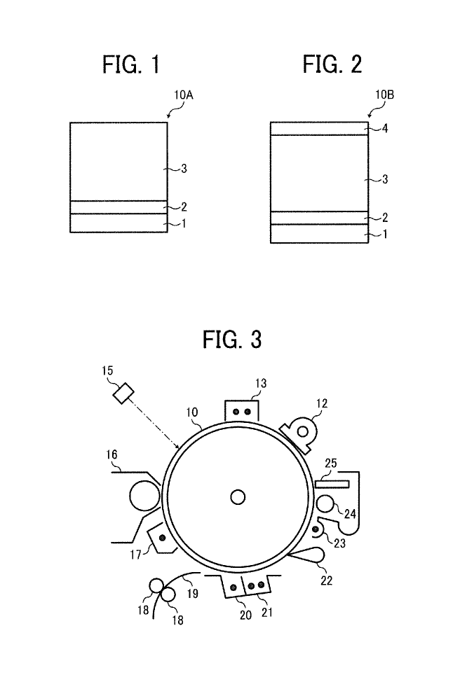

FIG. 1 shows a cross sectional view of one example of a layer configuration of the photoreceptor according to the embodiment. A photoreceptor 10A of this embodiment has a laminate structure in which a charge generating layer 2 having a charge generating material as the main component and a charge transport layer having a charge transport material as the main component are laminated on an electroconductive substrate 1.

FIG. 2 is a cross sectional view of another example of a layer configuration of a photoreceptor according to the embodiment. A photoreceptor 10B of this embodiment has a laminate structure in which the charge generating layer 2 having a charge generating material as the main component and the charge transport layer 3 having a charge transport material as the main component are laminated on the electroconductive substrate 1, and a surface layer 4 is further provided thereon.

The charge generating layer and the charge transport layer are not necessarily arranged in this order as shown in FIGS. 1 and 2 and can be provided in the reversal order.

Electroconductive Substrate

Any electroconductive substrate 1 having a volume resistance of 10¹⁰ Ω·cm or less can be suitably used.

Specific examples of the material of the support include, but are not limited to, metals such as Al, Ni, Cr, Cu, Au, Ag, and Pt or alloys thereof; articles obtained by coating a film-shaped or cylindrical plastic or a paper with a metal oxide such as tin oxide and indium oxide by vapor deposition or sputtering; plates of aluminum, an aluminum alloy, nickel, stainless and the like, or pipes obtained by forming the above-mentioned plate into a rough pipe by a technique such as extrusion or drawing, and subjecting the rough pipe to a surface treatment such as cutting, super-finishing and polishing. The endless nickel belt and endless stainless belt disclosed in JP-52-36016-A can also be used.

An article obtained by dispersing an electroconductive powder in a binder resin and applying the dispersion to the aforementioned support may also be used.

Examples of the electroconductive powder include carbon black and acetylene black; powders of metals such as aluminum, nickel, iron, nichrome, copper, zinc and silver; and powders of metal oxides such as electroconductive tin oxide and ITO.

Examples of the binder resin include a polystyrene resin, a styrene-acrylonitrile copolymer, a styrene-butadiene copolymer, a styrene-maleic anhydride copolymer, a polyester resin, a polyvinyl chloride resin, a vinyl chloride-vinyl acetate copolymer, a polyvinyl acetate resin, a polyvinylidene chloride resin, a polyarylate resin, a phenoxy resin, a polycarbonate resin, a cellulose acetate resin, an ethyl cellulose resin, a polyvinyl butyral resin, a polyvinyl formal resin, a polyvinyl toluene resin, a poly-N-vinylcarbazole, an acryl resin, a silicone resin, an epoxy resin, a melamine resin, an urethane resin, a phenol resin and an alkyd resin.

A method for dispersing electroconductive powder in a binder resin and applying the liquid dispersion can be conducted by dispersing the aforementioned electroconductive powder and binder resin in, for example, a solvent such as tetrahydrofuran, dichloromethane, methyl ethyl ketone or toluene followed by application of the thus-obtained liquid dispersion.

In addition, the electroconductive substrate may be formed by providing an electroconductive layer on a cylindrical substrate of polyvinyl chloride, polypropylene, polyester, polystyrene, polyvinylidene chloride, polyethylene, rubber chloride, Teflon® or the like using a heat-shrinkable tube containing the aforementioned electroconductive powder.

Charge Generating Layer

The charge generating layer 2 in this embodiment contains a charge generating material as the main component. There is no specific limit to the charge generating material. Specific examples thereof include, but are not limited to, monoazo pigments, disazo pigments, trisazo pigments, perylene-based pigments, perinone-based pigments, quinacridone-based pigments, quinone-based fused polycyclic compounds, squaric acid-based dyes, other phthalocyanine-based pigments, naphthalocyanine-based pigments and azulenium salt-based dyes. These may be used alone or in combination.

For example, the charge generating layer 2 is formed by dispersing a charge generating material in a solvent optionally with a binder resin using a ball mill, an attritor, a sand mill, ultrasonics, or the like, and applying the thus-obtained liquid dispersion to the aforementioned electroconductive substrate followed by drying.

There is no specific limit to the binder resin contained in the charge generating layer. Specific examples thereof include, but are not limited to, a polyamide resin, a polyurethane resin, an epoxy resin, a polyketone resin, a polycarbonate resin, a silicone resin, an acryl resin, a polyvinyl butyral resin, a polyvinyl formal resin, a polyvinyl ketone resin, a polystyrene resin, a polysulfone resin, a poly-N-vinylcarbazole resin, a polyacrylamide resin, a polyvinyl benzal resin, a polyester resin, a phenoxy resin, a vinyl chloride-vinyl acetate copolymer, a polyvinyl acetate resin, a polyphenylene oxide resin, a polyamide resin, a polyvinyl pyridine resin, a cellulose-based resin, a casein resin, a polyvinyl alcohol resin and a polyvinyl pyrrolidone resin. These may be used alone, or used in combination.

The content of the binder resin is normally 0 to 500 parts by weight, preferably 10 parts to 300 parts by weight, based on 100 parts by weight of the charge generating material. The binder resin may be added either before or after the dispersion.

Specific examples of the solvent contained in a coating solution used in formation of the charge generating layer include, but are not limited to, isopropanol, acetone, methyl ethyl ketone, cyclohexane, tetrahydrofuran, dioxane, ethyl cellosolve, ethyl acetate, methyl acetate, dichloromethane, dichloroethane, monochlorobenzene, cyclohexane, toluene, xylene and ligroin.

Among these, a ketone-based solvent, an ester-based solvent and an ether-based solvent are preferably used. The aforementioned solvents may be used alone, or used in combination.

The charge generating layer can be formed by, for example, dispersing a charge generating material in a solvent optionally with a binder resin using a dispersing device such as a ball mill, an attritor, a sand mill, a bead mill or ultrasonics as described above, to prepare a coating solution. The charge generating layer has a charge generating material, a solvent, and a binder resin as main components, but may contain other additives. Specific examples thereof include, but are not limited to, a sensitizing agent, a dispersant, a surfactant, and a silicone oil.

Thereafter, the coating solution is applied by a method such as a dip coating method, a spray coating method, a beat coating method, a nozzle coating method, a spinner coating method, or a ring coating method.

The thickness of the charge generating layer is normally from 0.01 μm to 5 μm and preferably from 0.1 μm to 2 μm.

Charge Transport Layer

The charge transport layer 3 in this embodiment contains a charge transport material and a binder resin as the main components.

The charge transport layer in this embodiment contains a compound represented by the following formula 1 and a compound represented by the following formula 2.

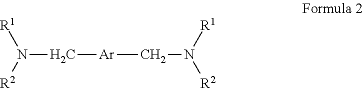

In the formula 1, R¹ and R² each independently represent substituted or non-substituted alkyl groups or aromatic hydrocarbon groups and one of R¹ and R² represents a substituted or -non-substituted aromatic hydrocarbon group. R¹ and R² bonded to the same nitrogen atom may be bonded together to form a substituted or non-substituted nitrogen-containing heterocyclic group. Ar represents a substituted or non-substituted hydrocarbon group.

Examples of the compound represented by the formula 1 are shown in Tables 1 to 3, but the compound in the charge transport layer in the present invention is not limited to those shown in Tables 1 to 3.

TABLE 1

| Compound | | | |
|---|---|---|---|
| No. | | | |
| 1-1 | 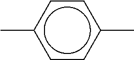 | —CH₃ | 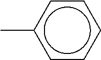 |
| 1-2 | 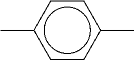 | —CH₂CH₃ | 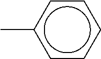 |
| 1-3 | 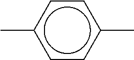 | —CH₃ | 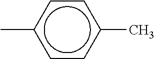 |
| 1-4 | 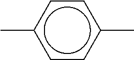 | —CH₂CH₃ | 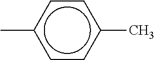 |
| 1-5 | 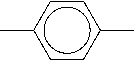 | —CH₂CH₂CH₃ | 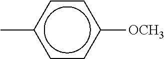 |
| 1-6 | 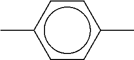 | —CH₂CH₃ | 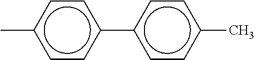 |
| 1-7 | 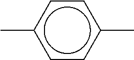 | 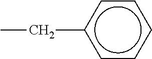 | 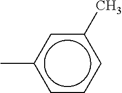 |
| 1-8 | 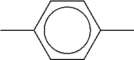 | 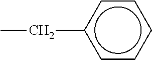 | 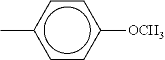 |
| 1-9 | 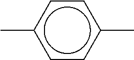 | —CH₂CH₃ | 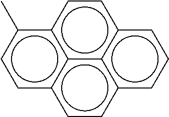 |
| 1-10 | 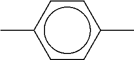 | 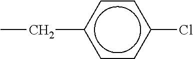 | 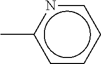 |
| 1-11 | 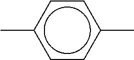 | —CH₂CH₃ | 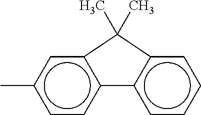 |
| 1-12 | 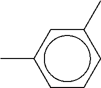 | —CH₂CH₃ | 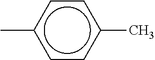 |
| 1-13 | 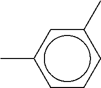 | 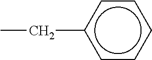 | 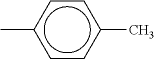 |

TABLE 2

| Compound | | | |
|---|---|---|---|
| No. | | | |
| 1-14 | 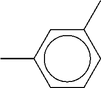 | 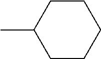 | 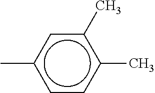 |
| 1-15 | 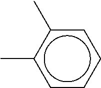 | —CH₂CH₃ | 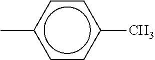 |
| 1-16 | 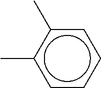 | —CH₃ | 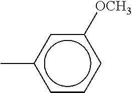 |
| 1-17 | 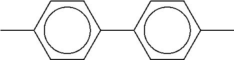 | —CH₂CH₃ | 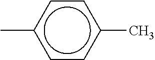 |
| 1-18 | 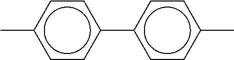 | 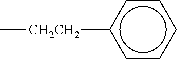 | 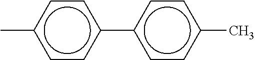 |
| 1-19 | 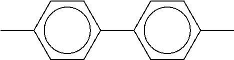 | —CH₃ | 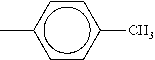 |
| 1-20 | 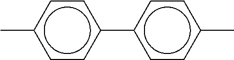 | —CH₂CH₃ | 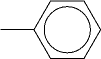 |
| 1-21 | 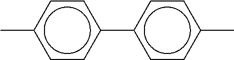 | 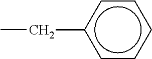 | 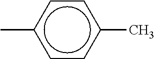 |
| 1-22 | 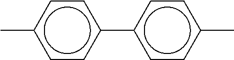 | 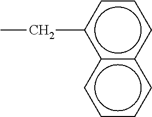 | 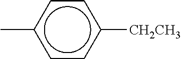 |
| 1-23 | 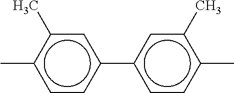 | —CH₂CH₃ | 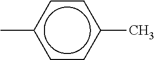 |
| 1-24 | 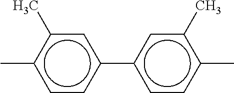 | 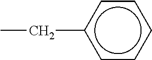 | 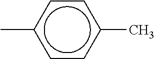 |
| 1-25 | 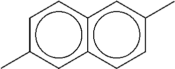 | —CH₂CH₃ | 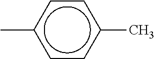 |

TABLE 3

| Compound | | | |
|---|---|---|---|
| No. | | | |
| 1-26 | 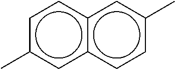 | —CH₃ | 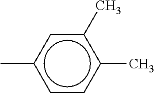 |
| 1-27 | 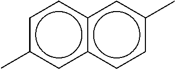 | 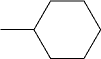 | 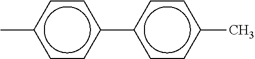 |
| 1-28 | 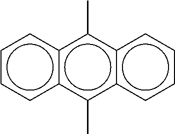 | —CH₂CH₃ | 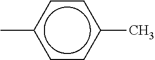 |
| 1-29 | 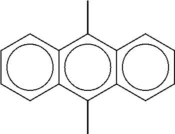 | —CH₃ | 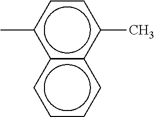 |
| 1-30 | 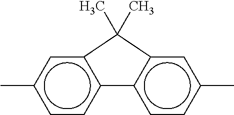 | —CH₂CH₃ | 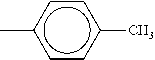 |
| 1-31 | 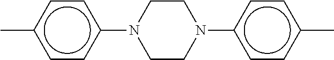 | —CH₂CH₃ | 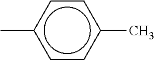 |
| 1-32 | 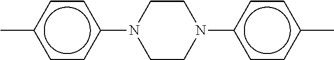 | —CH₂CH₃ | 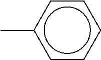 |
| 1-33 | 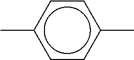 | —CH₂CH₃ | 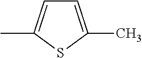 |
| 1-34 | 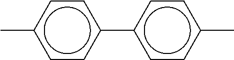 | 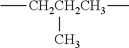 | 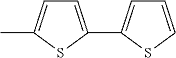 |

| | | |
|---|---|---|
| 1-35 | 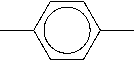 | 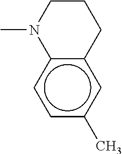 |
| 1-36 | 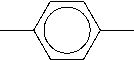 | 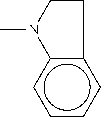 |
| 1-37 | 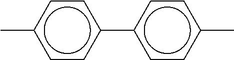 | 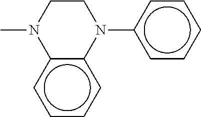 |

The compound represented by the formula 2 is illustrated below.

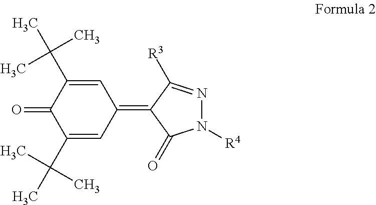

In the formula 2, R³ and R⁴ each independently represent a substituted or non-substituted alkyl group or aromatic hydrocarbon group.

Examples of the compound represented by the formula 2 are shown in Table 4, but the compound in the charge transport layer in the present invention is not limited to those shown in Table 4.

TABLE 4

| Com- | |
|---|---|
| pound | |
| No. | |
| 2-1 | 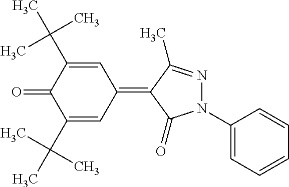 [SMILES: CC1=NN(c2ccccc2)C(=O)C1=C1C=C(C(C)(C)C)C(=O)C(C(C)(C)C)=C1] |
| 2-2 | 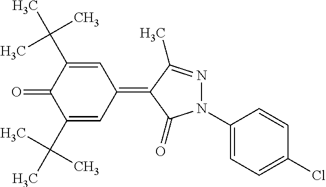 [SMILES: CC1=NN(c2ccc(Cl)cc2)C(=O)C1=C1C=C(C(C)(C)C)C(=O)C(C(C)(C)C)=C1] |
| 2-3 | 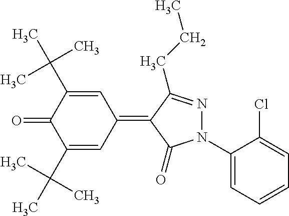 [SMILES: CCCC1=NN(c2ccccc2Cl)C(=O)C1=C1C=C(C(C)(C)C)C(=O)C(C(C)(C)C)=C1] |
| 2-4 | 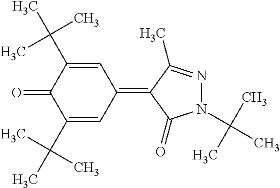 [SMILES: CC1=NN(C(C)(C)C)C(=O)C1=C1C=C(C(C)(C)C)C(=O)C(C(C)(C)C)=C1] |
| 2-5 | 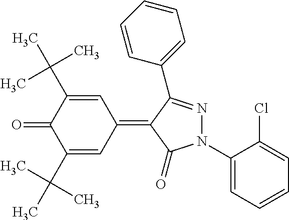 [SMILES: CC(C)(C)C1=CC(=C2C(=O)N(c3ccccc3Cl)N=C2c2ccccc2)C=C(C(C)(C)C)C1=O] |
| 2-6 | 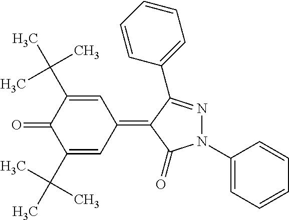 [SMILES: CC(C)(C)C1=CC(=C2C(=O)N(c3ccccc3)N=C2c2ccccc2)C=C(C(C)(C)C)C1=O] |
| 2-7 | 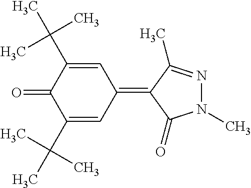 [SMILES: CC1=NN(C)C(=O)C1=C1C=C(C(C)(C)C)C(=O)C(C(C)(C)C)=C1] |
| 2-8 | 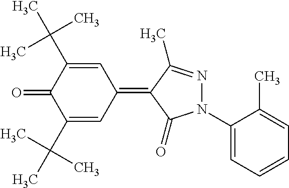 [SMILES: CC1=NN(c2ccccc2C)C(=O)C1=C1C=C(C(C)(C)C)C(=O)C(C(C)(C)C)=C1] |
| 2-9 | 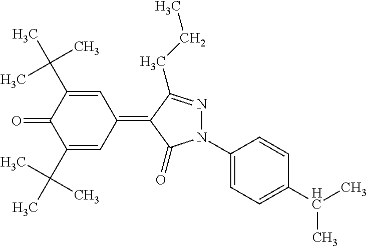 [SMILES: CCCC1=NN(c2ccc(C(C)C)cc2)C(=O)C1=C1C=C(C(C)(C)C)C(=O)C(C(C)(C)C)=C1] |
| 2-10 | 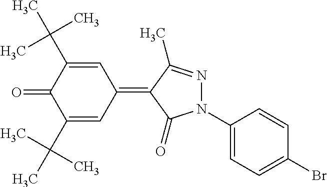 [SMILES: CC1=NN(c2ccc(Br)cc2)C(=O)C1=C1C=C(C(C)(C)C)C(=O)C(C(C)(C)C)=C1] |

Since the charge transport layer in this embodiment contains a compound represented by the formula 1, a photoreceptor excellent in gas resistance can be obtained. Unlike other antioxidants, the compound represented by the formula 1 is not or little degraded with regard to characteristics such as an increase in exposed-area potential. This is because the compound represented by the formula 1 preferentially acts on an oxidative gas, thereby suppressing degeneration of constituent materials of the photoreceptor. Accordingly, when the photoreceptor is used for a long time, the compound of the formula 1 is degraded to form a trap in a photosensitive layer, so that the exposed-area potential, especially a variation within a job, increases.

However, the photoreceptor of this embodiment contains a compound represented by the formula 2. The photoreceptor containing a compound represented by the formula 2 reduces an increase in the change within a job even in usage for a long time. The mechanism for this is not clear, but it is inferred that the compound represented by the formula 2 efficiently inactivates a state in which the compound represented by the formula 1 is activated by an oxidative gas. Accordingly, degradation of the compound represented by the formula 1 is reduced, so that the gas resistance is maintained even if the photoreceptor is used for a long time and hence a variation within a job is reduced.

The charge transport material used in the charge transport layer in this embodiment may be an electron transport material, or may be a hole transport material.

Specific examples of the electron transport materials include, but are no limited to, electron-accepting substances such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, and benzoquinone derivatives.

Specific examples of the hole transport materials include, but are not limited to, poly-N-vinylcarbazole and derivatives thereof, poly-γ-carbazolylethyl glutamate and derivatives thereof, pyrene-formaldehyde condensates and derivatives thereof, polyvinyl pyrene, polyvinyl phenanthrene, polysilane, oxazole derivatives, oxadiazole derivatives, imidazole derivatives, monoarylamine derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives and the like, bisstilbene derivatives, enamine derivatives and the like, and other known materials.

The charge transport materials may be used alone or in combination.

Specific examples of the binder resins contained in the charge transport layer include, but are not limited to, thermoplastic or thermosetting resins such as polystyrene, a styrene-acrylonitrile copolymer, a styrene-butadiene copolymer, a styrene-maleic anhydride copolymer, polyester, polyvinyl chloride, a vinyl chloride-vinyl acetate copolymer, polyvinyl acetate, polyvinylidene chloride, a polyarylate resin, a phenoxy resin, polycarbonate, a cellulose acetate resin, an ethyl cellulose resin, polyvinyl butyral, polyvinyl formal, polyvinyl toluene, poly-N-vinylcarbazole, an acryl resin, a silicone resin, an epoxy resin, a melamine resin, an urethane resin, a phenol resin and an alkyd resin.

The content of the charge transport material is preferably from 20 parts by weight to 300 parts by weight, more preferably from 40 parts by weight to 150 parts by weight, based on 100 parts by weight of the binder resin.

The content of the compound represented by the formula 1 is preferably from 1 part by weight to 30 parts by weight, more preferably from 5 parts by weight to 15 parts by weight, based on 100 parts by weight of the charge transport material. The content of the compound represented by the formula 2 is preferably from 0.5 parts by weight to 10 parts by weight, more preferably from 1 part by weight to 5 parts by weight, based on 100 parts by weight of the charge transport material. If the content of the compound represented by the formula 1 or the formula 2 is excessively small, the effect described above may not be obtained. To the contrary, if the content of the compound represented by the formula 1 or the formula 2 is large, the exposed-area potential and the variation within Job may increase.

The charge transport layer is formed by, for example, dissolving the charge transport material and the binder resin in a solvent to prepare a coating solution and thereafter, applying the coating solution using a conventional coating method such as a dip coating method, a spray coating method, a beat coating method, a nozzle coating method, and a spinner coating method, or a ring coating method.

As the solvent in the coating solution, for example, tetrahydrofuran, dioxane, toluene, dichloromethane, monochlorobenzene, dichloroethane, cyclohexanone, methyl ethyl ketone, acetone and the like can be used. These solvents may be used alone or in combination.

The thickness of the charge transport layer is normally 50 μm or less and preferably 25 μm or less in light of resolution, responsiveness, etc. The lower limit of the thickness of the charge transport layer depends on a system used (e.g. charging potential, etc.), but is preferably 5 μm or more.

Surface Layer

The photoreceptor of this embodiment preferably has a surface layer to protect a photosensitive layer, etc. The surface layer 4 is normally provided on the charge transport layer 3.

As the surface layer, a layer containing a cross-linkable resin, a layer containing a filler, or the like is preferably used because it has a high wear resistance.

Preferably the layer containing a cross-linkable resin is cured to form a three-dimensional network structure by using a radical-polymerizable monomer and a radical-polymerizable compound having a charge transport structure because the thus-obtained surface layer has a high degree of cross-linking and a high hardness.

The surface layer preferably includes a layer containing a filler to enhance the mechanical durability of the surface layer. In particular, when the surface layer contains a cross-linkable resin, inclusion of a filler therein is preferable in terms of enhancing the wear resistance and prolonging the working life of the photoreceptor.

There is no specific limit to the filler. Specific examples thereof include, but are not limited to, titanium oxide, tin oxide, zinc oxide, zirconium oxide, indium oxide, antimony oxide, boron nitride, silicon nitride, calcium oxide, barium sulfate, ITO, silicon oxide, colloidal silica, aluminum oxide or the like can be used. Among them, aluminum oxide, titanium oxide, silicon oxide or tin oxide is preferably used in terms of the electrical characteristics of the surface layer.

The average primary particle diameter of the filler preferably ranges from 0.01 μm to 0.5 μm in terms of the light transmittance and wear resistance of the surface layer. If the average primary particle diameter of the filler is too small, the wear resistance, dispersibility, etc. may be deteriorated. To the contrary, if the average primary particle diameter of the filler is to large, a blade cleaning member described later may wear quickly because the surface roughness of the surface layer increases. Consequently, a toner cleaning failure may occur, or sedimentation of the filler in a dispersion liquid may be accelerated depending on the specific gravity of filler particles, or the like.

The concentration of a filler material in the surface layer is normally 50% by mass or less, preferably 30% by mass or less, based on the total solid content. The wear resistance is enhanced as the concentration of the filler material in the surface layer increases, but if the concentration of the filler material is too high, the residual potential may become high, or writing light on the surface layer may be scattered, leading to a reduction in transmittance.

Other Layers

The photoreceptor of this embodiment may include other layers. For example, an undercoating layer can be arranged between the electroconductive substrate and the charge generating layer.

The undercoating layer has a resin as the main component and preferably contains a resin having a high solvent resistance to an organic solvent.

Specific examples of the resins used in the undercoating layer in this embodiment include, but are not limited to, water-soluble resins such as polyvinyl alcohol, casein, and sodium polyacrylate, alcohol-soluble resins such as copolymerized nylon, and methoxymethylated nylon, and curable resins that form a three-dimensional network structure, such as polyurethane, a melamine resin, a phenol resin, an alkyd-melamine resin, and an epoxy resin.

The undercoating layer preferably contains a fine powder pigment of a metal oxide such as titanium oxide, silica, alumina, zirconium oxide, tin oxide or indium oxide in terms of prevention of moire, reduction of the residual potential, and so on.

The undercoating layer can be formed by, for example, using a coating method as in the case of the photosensitive layer.

The undercoating layer may be a metal oxide deposited by a sol-gel method using a silane coupling agent, a titanium coupling agent, chromium coupling agent or the like, aluminum oxide deposited by anodic oxidation, an organic substance such as polyparaxylylene (parylene), or silicon oxide, tin oxide (IV), titanium dioxide, ITO, a cerium oxide or the like deposited by a method of preparing a thin film under vacuum.

The thickness of the undercoating layer is normally 0 to 5 μm.

In this embodiment, additives such as an antioxidant, a plasticizer, lubricant and an ultraviolet light absorber may be added to each of the photosensitive layer, the cross-linked surface layer, the charge transport layer, the charge generating layer, the undercoating layer and so on in terms of improvement of environmental resistance, prevention of a reduction in sensitivity, prevention of an increase in residual potential, and so on.

Image Forming Method and Image Forming Apparatus

The image forming method in this embodiment includes a transfer step of transferring a toner image to an image bearing material (transfer sheet) after passing through processes of, for example, a charging step of charging a photoreceptor, an exposure step, a development step and so on using the photoreceptor of this embodiment. The image forming method of this embodiment may further include a fixing step and an optional step of cleaning the surface of the photoreceptor.

The image forming apparatus of this embodiment forms images by the above-described image forming method using the photoreceptor of this embodiment. The image forming apparatus of this embodiment includes, for example, a charging device for charging a photoreceptor, an exposure device, a development device, and a transfer device. The image forming apparatus of this embodiment optionally includes a fixing device and a cleaning device.

The image forming apparatus of this embodiment may have a configuration in which a plurality of image formation elements including charging devices, exposure devices, development devices, transfer devices, and photoreceptors are arranged.

FIG. 3 shows a schematic diagram of one example of an image forming apparatus according to the embodiment.

In the image forming method of this embodiment, first a photoreceptor 10 is charged by charging device 13.

A charger can be used as the charging device to charge the photoreceptor 10. In addition, a corotron, a scorotron, a solid discharger, a needle electrode device, a roller charging device, or an electroconductive brush device can be used. There is no specific limit to the charging method. Specific examples thereof include, but are not limited to, a contact charging method and a non-contact proximity charging method. These methods are particularly suitable when a charging device uses a proximity discharge, which may decompose photoreceptor composition.

In the contact charging method mentioned herein, a charging roller, a charging brush, a charging blade or the like directly contacts a photoreceptor. On the other hand, in the non-contact proximity charging method, for example, a charging roller is arranged between the surface of the photoreceptor and the charging device with a gap of, for example, 200 μm or less between the charging roller and the photoreceptor.

The gap is normally from 10 μm to 200 μm and preferably 10 μm to 100 μm. If the gap is too large, charging may be unstable. To the contrary, if the gap is too small, the surface of a charging member may be contaminated by residual toner remaining on the photoreceptor.

Next, an exposure device 15 irradiates the surface of the charged photoreceptor 10 to form a latent electrostatic image.

As the light source for the exposure device 15, a fluorescent lamp, a tungsten lamp, a halogen lamp, a mercury lamp, a sodium lamp, a light emitting diode (LED), a semiconductor laser (LD), an electroluminescence (EL) or the like can be used. For irradiation of light having a particular wavelength range, various filters such as a sharp cut filter, a bandpass filter, a near infrared cut filter, a dichroic filter, an interference filter and a conversion filter for color temperature may be used.

Next, the latent electrostatic image formed on the photoreceptor 10 is rendered visible using a development device 16. A single component development method using a dry toner, a two component development method, or a wet development method using a wet toner can be employed to develop the latent electrostatic image.

When the photoreceptor is negatively charged to perform image exposure, a positive latent electrostatic image is formed on the surface of the photoreceptor in the case of reversal development. When the positive latent electrostatic image is developed with a toner of negative polarity (electroscopic fine particles), a positive image is obtained, and when the positive latent electrostatic image is developed with a toner of positive polarity, a negative image is obtained. On the other hand, in the case of normal development, a negative latent electrostatic image is formed on the surface of the photoreceptor. When the negative latent electrostatic image is developed with a toner of positive polarity (electroscopic fine particles), a positive image is obtained, and when the negative latent electrostatic image is developed with a toner of negative polarity, a negative image is obtained.

Next, the toner image on the photoreceptor is transferred onto a transfer medium 19 using a transfer device 20. The transfer medium 19 is transferred by a registration roller 18, etc. such that the toner image is transferred to a desired position on the transfer medium 19. As the transfer device 20, for example, a transfer charger can be used. A pre-transfer charger 17 may be used to secure good transfer of the image.

For example, the aforementioned transfer charger, an electrostatic transfer method using a bias roller, an adhesive transfer method, a mechanical transfer method such as a pressure transfer method, a magnetic transfer method or the like can be employed. When the electrostatic transfer method is used, the aforementioned charging device can be used.

Next, the transfer medium 19 is separated from the photoreceptor 10 using a separation device. For example, a separation charger 21 or a separation claw 22 can be used as the separation device. The transfer medium 19 can also be separated by using electrostatic absorption guiding separation, side end belt separation, front end grip transfer, curvature separation, etc. As for the separation charger 21, the same method as that for the aforementioned charging device can be used.

Next, toner left on the photoreceptor after transfer is removed using the cleaning device. For example, a fur brush 24, a cleaning blade 25 or the like can be used as the cleaning device.

In this embodiment, a pre-cleaning charger 23 is preferably used for better cleaning.

Specific examples of other cleaning devices include, but are not limited to, a web-type cleaning device and a magnet brush-type cleaning device. These cleaning devices may be used alone or in combination.

Next, the latent image on the photoreceptor is removed using a discharging device 12, if desired. For example, a discharging lamp, a discharging charger and the like can be used as the discharging device 12. The lamps and chargers described for the aforementioned exposure device, charging device and the like can be used.

There is no specific limit to processes such as document reading, sheet feeding, fixing, and sheet discharging. Any conventional processes can be used.

An image forming device using the photoreceptor of this embodiment may be fixedly incorporated in, for example, a photocopier, a facsimile machine, or a printer, but may be incorporated in the above-mentioned apparatus in the form of a detachably attachable process cartridge.

Process Cartridge

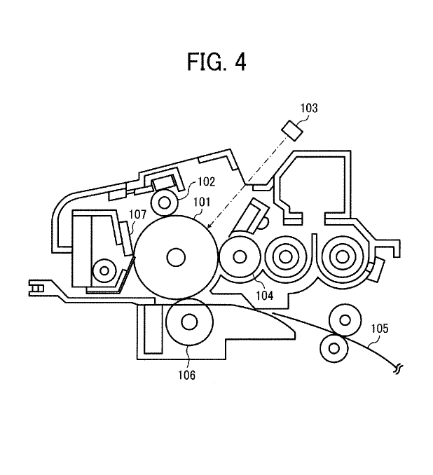

FIG. 4 shows a schematic diagram of an example of a process cartridge according to the embodiment.

The process cartridge of this embodiment includes the photoreceptor of this embodiment, and at least one selected from the group consisting of a charging device, a development device, a transfer device, a cleaning device, and a discharging device, and is detachably attachable to the image forming apparatus.

The process cartridge of this embodiment includes a photoreceptor 101 of this embodiment, and at least one device selected from the group consisting of a charging device 102, a development device 104, a transfer device 106, a cleaning device 107, and a discharging device. The process cartridge is detachably attachable to the image forming apparatus.

An example of an image formation process using the cartridge shown in FIG. 4 is described. While the photoreceptor 101 is rotated, a latent electrostatic image corresponding to an exposure pattern is formed on the surface thereof through charging by the charging device 102 and exposure by the exposure device 103. The latent electrostatic image formed is developed with toner by the development device 104 to obtain a visible image, which is transferred onto a transfer medium 105 by the transfer device 106 and printed out. Then, the surface of the photoreceptor after transfer of the image is cleaned by the cleaning device 107 and electrically neutralized by a discharging device to be ready for the next image forming.

Having generally described preferred embodiments, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present disclosure is described below using Examples, but the present invention is not limited thereto.

Synthesis of Titanyl Phthalocyanine Crystal

A titanyl phthalocyanine crystal was synthesized in accordance with the method described in JP-2004-83859-A.

First, 292 parts of 1,3-diiminoisoindoline and 1,800 parts of sulfolane were mixed, and 204 parts of titanium tetrabutoxide was added dropwise under a nitrogen gas atmosphere. After completion of the dropwise addition, the temperature was gradually elevated to 180° C., and the mixture was stirred for 5 hours for reaction while keeping the reaction temperature between 170° C. and 180° C.

After completion of the reaction, the reaction product was cooled down, and a precipitate was filtered, washed with chloroform until the powder turned blue, and subsequently washed several times with methanol. Further, the precipitate was washed several times with hot water at 80° C., and then dried to obtain coarse titanyl phthalocyanine.

The coarse titanyl phthalocyanine was dissolved in concentrated sulfuric acid the amount of which is 20 times as much as that of the coarse titanyl phtoalocycnine. Thereafter, the solution was added dropwise to ice water the amount of which is 100 times as much as that of the solution while stirring and the thus-obtained precipitated crystal was filtered. Next, rinsing was repeated with deionized water (pH: 7.0; specific conductivity: 1.0 μS/cm) until the washing fluid became neutral (the pH value was 6.8 and the specific conductivity was 2.6 μS/cm for deionized water after washing) to obtain a wet cake (water paste) of a titanyl phthalocyanine pigment.

Into 200 parts of tetrahydrofuran was added 40 parts of the resulting wet cake (water paste), and the mixture was stirred (2000 rpm) at room temperature by a homomixer (MARKIIf Model from KENIS, Ltd.), and when the color of the paste changed from dark blue to light blue (20 minutes after the start of stirring), stirring was stopped followed by immediate filtration under a reduced pressure. The resulting crystal was washed with tetrahydrofuran on a filter to obtain a wet cake of a pigment.

The resulting wet cake was dried at 70° C. under a reduced pressure (5 mmHg) for 2 days to obtain 8.5 parts of a titanyl phthalocyanine crystal. The solid concentration of the aforementioned wet cake was 15 percent by mass. The crystal conversion solvent was used 33 times as much as the amount of the wet cake by a mass ratio. A halogen-containing compound was not used in the raw material for synthesis.

The resulting titanyl phthalocyanine powder was subject to an x-ray diffraction spectrum measurement under the following conditions to find that the titanyl phthalocyanine powder had a maximum peak at 27.2°±0.2°, a peak at a minimum angle of 7.3°±0.2°, main peaks 9.4°±0.2°, 9.6°±0.2° and 24.0°±0.2°, no peak between the peak at 7.3° and the peak at 9.4°, and no peak at 26.3° in terms of Bragg angle 2θ to the CuKα ray (wavelength: 1.542 angstroms).

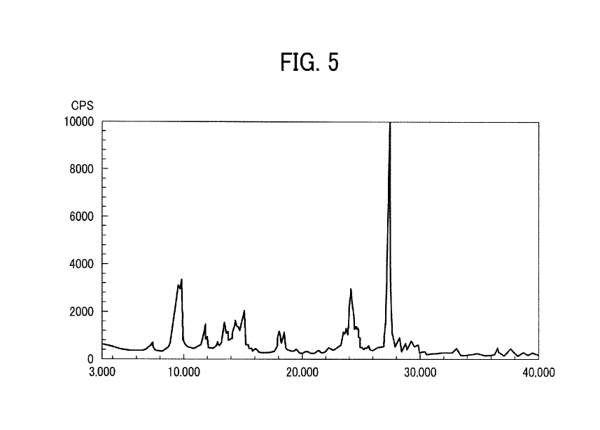

FIG. 5 is a graph illustrating one example of the result of an X-ray diffraction spectrum measurement of titanyl phthalocyanine in the embodiment. Measurement conditions for the X-ray diffraction spectrum measurement were as follows:

X-ray tube: Cu,
voltage: 50 kV,
current: 30 mA,
scanning speed: 2°/minute,
scanning range: 3° to 40°,
time constant: 2 seconds.

### Example 1

A substrate made of aluminum (outer diameter: 60 mmφ) was coated with the following undercoating layer coating solution by a dipping method followed by drying at 130° C. for 20 minutes to obtain an undercoating layer having a thickness of 3.5 μm.

The undercoating layer coating solution contained:

400 parts of a titanium dioxide powder (Taibake CR-EL, manufactured by Ishihara Sangyo Kaisha, Ltd.),

65 parts of a melamine resin (Super Beckamine G821-60, manufactured by DIC Corporation),

120 parts of an alkyd resin (Beckolite M6401-50, manufactured by DIC Corporation), and

400 parts of 2-butanone.

The formed undercoating layer was dip-coated with the following charge generating layer coating solution followed by drying by heating at 90° C. for 20 minutes to form a charge generating layer having a thickness of 0.2 μm.

The charge generating layer coating solution contained:

8 parts of titanyl phthalocyanine,

5 parts of polyvinyl butyral (BX-1 manufactured by Sekisui Chemical Company, Limited), and

400 parts of 2-butanone.

The resulting charge generating layer was dip-coated with the following charge transport layer coating solution followed by drying by heating at 120° C. for 20 minutes to form a charge transport layer having a thickness of 25 μm.

The charge transport layer coating solution contained:

10 parts of Z-type polycarbonate (TS-2050 manufactured by Teijin Chemicals Ltd.),

10 parts of the hole transport compound represented by the following Chemical Structure 1 (CTM1),

1 part of the illustrated compound 1-1 in Tables 1 to 3,

0.3 parts of the illustrated compound 2-3 in Table 4, and

100 parts of tetrahydrofuran.

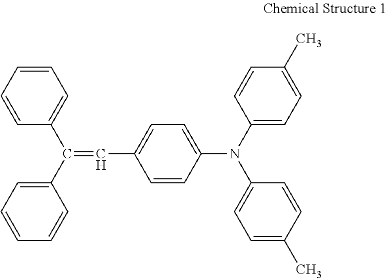 [SMILES: Cc1ccc(N(c2ccc(C)cc2)c2ccc(C=C(c3ccccc3)c3ccccc3)cc2)cc1]

The resulting charge transport layer was spray-coated with the following surface layer coating solution, and the coating solution was irradiated with light using a metal halide lamp (conditions of irradiation intensity: 500 mW/cm² and irradiation time: 160 seconds). Further, drying was performed at 130° C. for 30 minutes to provide a surface layer having a thickness of 4.0 μm, thereby obtaining a photoreceptor of Example 1.

The surface layer coating solution contained:

10 parts of a radical polymerizable monomer (trimethylolpropane acrylate) (KAYARAD TMPTA, manufactured by Nippon Kayaku Co., Ltd.),

10 parts of the compound of the following structural formula (2),

1 part of a photopolymerization initiator (IRGACURE 184, manufactured by Ciba Specialty Chemicals Inc.), and

100 parts of tetrahydrofuran.

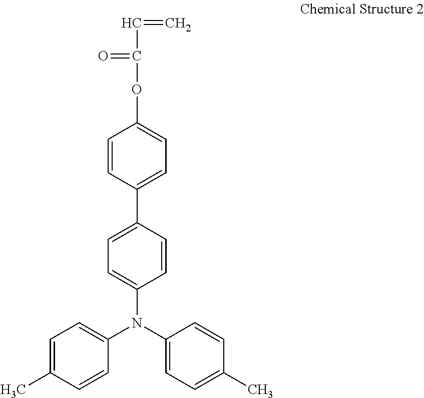

### Example 2

A photoreceptor of Example 2 was obtained by the same method as in Example 1 except that the charge transport layer coating solution was changed so as to contain the illustrated compound 1-6 in place of the illustrated compound 1-1 in Tables 1 to 3, and the illustrated compound 2-6 in place of the illustrated compound 2-3 in Table 4.

### Example 3

A photoreceptor of Example 3 was obtained by the same method as in Example 1 except that the charge transport layer coating solution was changed so as to contain the illustrated compound 1-25 in place of the illustrated compound 1-1 in Tables 1 to 3, and the illustrated compound 2-7 in place of the illustrated compound 2-3 in Table 4, and further the surface layer coating solution was changed to the following coating solution.

The surface layer coating solution contained:

3.0 parts of alumina (AA03 manufactured by Sumitomo Chemical Company, Limited),

0.06 parts of an unsaturated polycarboxylic acid polymer (BYK-P104 manufactured by BYK Chemie Ltd.),

5 parts of a radical polymerizable monomer (trimethylolpropane acrylate) (KAYARAD TMPTA manufactured by Nippon Kayaku Co., Ltd.),

5 parts of a radical polymerizable monomer (dipentaerythritolcaprolactone-modified hexaacrylate) (KAYARAD DPCA-120 manufactured by Nippon Kayaku Co., Ltd.),

10 parts of the compound of the structural formula (1),

1 part of a photopolymerization initiator (IRGACURE 184 manufactured by Ciba Specialty Chemicals Inc.), and

100 parts of tetrahydrofuran.

### Example 4

A photoreceptor of Example 4 was obtained by the same method as in Example 3 except that the charge transport layer coating solution was changed to the following coating solution.

The charge transport layer coating solution contained:

10 parts of Z-type polycarbonate (TS-2050 manufactured by Teijin Chemicals Ltd.),

10 parts of the hole transport material of the following structural formula (3) (CTM2),

1 part of the illustrated compound 1-35 in Tables 1 to 3,

0.3 parts of the illustrated compound 2-9 in Table 4, and

100 parts of tetrahydrofuran.

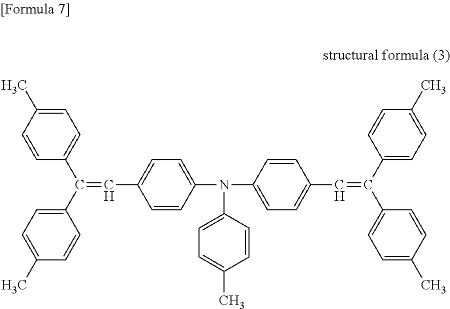 [SMILES: Cc1ccc(C(=Cc2ccc(N(c3ccc(C)cc3)c3ccc(C=C(c4ccc(C)cc4)c4ccc(C)cc4)cc3)cc2)c2ccc(C)cc2)cc1]

### Example 5

A photoreceptor of Example 5 was obtained by the same method as in Example 3 except that the charge transport layer coating solution was changed to the following coating solution in Example 3.

The charge transport layer coating solution included:

10 parts of Z-type polycarbonate (TS-2050 manufactured by Teijin Chemicals Ltd.),

10 parts of the hole transport material shown in the following structural formula (4) (CTM3),

0.1 part of the illustrated compound 1-17 in Tables 1 to 3,

0.3 parts of the illustrated compound 2-1 in Table 4, and

100 parts of tetrahydrofuran.

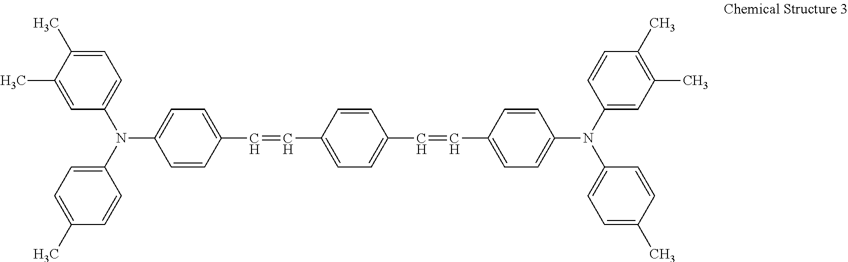

### Example 6

A photoreceptor of Example 6 was obtained by the same method as in Example 5 except that the added amount of the illustrated compound 1-17 in Tables 1 to 3 was changed to 0.5 parts in the charge transport layer coating solution.

### Example 7

A photoreceptor of Example 7 was obtained by the same method as in Example 5 except that the added amount of the illustrated compound 1-17 in Tables 1 to 3 was changed to 1 part in the charge transport layer coating solution.

### Example 8

A photoreceptor of Example 8 was obtained by the same method as in Example 5 except that the added amount of the illustrated compound 1-17 in Tables 1 to 3 was changed to 1.5 parts in the charge transport layer coating solution.

### Example 9

A photoreceptor of Example 9 was obtained by the same method as in Example 5 except that the added amount of the illustrated compound 2-1 in Table 4 was changed to 0.05 parts in the charge transport layer coating solution.

### Example 10

A photoreceptor of Example 10 was obtained by the same method as in Example 5 except that the added amount of the illustrated compound 2-1 in Table 4 was changed to 0.1 part in the charge transport layer coating solution.

### Example 11

A photoreceptor of Example 11 was obtained by the same method as in Example 5 except that the added amount of the illustrated compound 2-1 in Table 4 was changed to 0.5 parts in the charge transport layer coating solution.

### Example 12

A photoreceptor of Example 12 was obtained by the same method as in Example 5 except that the added amount of the illustrated compound 2-1 in Table 4 was changed to 1 part in the charge transport layer coating solution.

### Example 13

A photoreceptor of Example 13 was obtained by the same method as in Example 7 except that the surface layer coating solution was changed to the following coating solution, the charge transport layer was spray-coated thereon with the surface layer coating solution, and the coating was dried at 150° C. for 20 minutes to provide a surface layer having a thickness of 4.0 μm.

The surface layer coating solution contained:

3.0 parts of alumina (AA03 manufactured by Sumitomo Chemical Company, Limited),

0.06 parts of an unsaturated polycarboxylic acid polymer (BYK-P104 manufactured by BYK Chemie Ltd.),

10 parts of polycarbonate (Z Polica manufactured by Teijin Chemicals Ltd.),

4 parts of the hole transport material of the structural formula (1) (CTM1),

230 parts of tetrahydrofuran, and

70 parts of cyclohexanone.

### Comparative Example 1

A photoreceptor of Comparative Example 1 was obtained by the same method as in Example 3 except that the illustrated compound 2-7 in Table 4 was not added to the charge transport layer coating solution.

### Comparative Example 2

A photoreceptor of Comparative Example 2 was obtained by the same method as in Example 3 except that the illustrated compound 1-25 in Tables 1 to 3 was not added to the charge transport layer coating solution.

### Comparative Example 3

A photoreceptor of Comparative Example 3 was obtained by the same method as in Example 7 except that the illustrated compound 2-1 in Table 4 in the charge transport layer coating solution was changed to the compound of the following Chemical Structure 5.

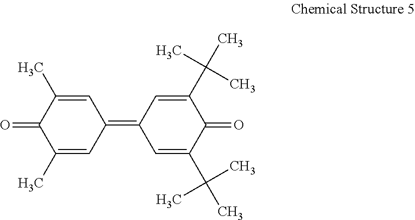 [SMILES: CC1=CC(=C2C=C(C(C)(C)C)C(=O)C(C(C)(C)C)=C2)C=C(C)C1=O]

### Comparative Example 4

A photoreceptor of Comparative Example 4 was obtained by the same method as in Example 7 except that the illustrated compound 2-1 in Table 4 in the charge transport layer coating solution was changed to the compound of the following Chemical Structure 6.

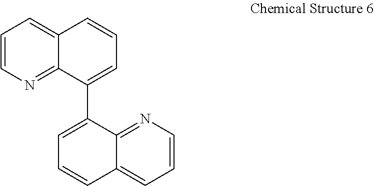 [SMILES: c1cnc2c(-c3cccc4cccnc34)cccc2c1]

### Comparative Example 5

A photoreceptor of Comparative Example 5 was obtained by the same method as in Example 7 except that the illustrated compound 2-1 in Table 4 in the charge transport layer coating solution was changed to the compound of the following Chemical Structure 7.

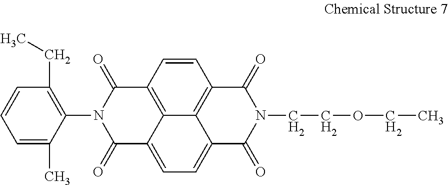 [SMILES: CCOCCN1C(=O)c2ccc3c4c(ccc(c24)C1=O)C(=O)N(c1c(C)cccc1CC)C3=O]

Evaluation

The photoreceptor obtained in each of Examples and Comparative Examples was attached to a cartridge for electrophotographic process, and mounted in a modified machine of a tandem-type full color digital copier (imagio MPC 7500, manufactured by RICOH Company, Ltd.). A printing durability test with a run length of 500,000 sheets using a chart with a writing ratio of 5% (text evenly printed which accounts for 5% of the entire surface of the A4 sheet) was conducted.

The exposed-area potential (VL) at the initial stage of the printing durability test and thereafter, the variation within Job, and the resolution power (image blur) after the printing durability test were evaluated. Evaluation results are shown in Table 5.

TABLE 5

| | Initial stage | | | After printing 500,000 sheets | | | |
|---|---|---|---|---|---|---|---|
| | | Variation | | | Variation | | |
| | VL | within Job | | VL | within Job | | Resolution |
| | (−V) | (V) | | (−V) | (V) | | power |
| Example 1 | 124 | 22 | ◯ | 141 | 29 | ◯ | ⊙ |
| Example 2 | 126 | 22 | ◯ | 143 | 28 | ◯ | ⊙ |
| Example 3 | 120 | 21 | ◯ | 143 | 28 | ◯ | ⊙ |
| Example 4 | 115 | 17 | ⊙ | 128 | 25 | ◯ | ⊙ |
| Example 5 | 92 | 8 | ⊙ | 100 | 10 | ⊙ | ◯ |
| Example 6 | 99 | 9 | ⊙ | 110 | 13 | ⊙ | ◯ |
| Example 7 | 109 | 12 | ⊙ | 126 | 18 | ⊙ | ⊙ |
| Example 8 | 125 | 17 | ⊙ | 138 | 26 | ◯ | ⊙ |
| Example 9 | 101 | 10 | ⊙ | 128 | 27 | ◯ | ⊙ |
| Example 10 | 105 | 12 | ⊙ | 125 | 25 | ◯ | ⊙ |
| Example 11 | 109 | 14 | ⊙ | 129 | 19 | ⊙ | ⊙ |
| Example 12 | 114 | 15 | ⊙ | 132 | 17 | ⊙ | ⊙ |
| Example 13 | 120 | 17 | ⊙ | 134 | 28 | ◯ | ⊙ |
| Comparative | 130 | 28 | ◯ | 176 | 65 | X | ⊙ |
| Example 1 | | | | | | | |
| Comparative | 123 | 22 | ◯ | 158 | 48 | X | Δ |
| Example 2 | | | | | | | |
| Comparative | 103 | 19 | ⊙ | 165 | 52 | X | ◯ |
| Example 3 | | | | | | | |
| Comparative | 120 | 22 | ◯ | 187 | 58 | X | ◯ |
| Example 4 | | | | | | | |
| Comparative | 107 | 18 | ⊙ | 170 | 51 | X | ⊙ |
| Example 5 | | | | | | | |

Variation within Job

For evaluation of the variation within Job, first an exposed-area potential (VL) of the photoreceptor was measured using a surface potential meter. A job of continuously printing the chart with a run length of 50 sheets was repeated ten times and thereafter an exposed-area potential was measured again. The initial exposed-area potential was subtracted from the exposed-area potential after the repeated printing to determine the variation within Job. In addition to the measured values, Table 5 shows whether or not the variation is correctable in use of the photoreceptor in the process.

Evaluation criteria of the variation within Job were as follows:

⊙: No problem

◯: Slight variation but correctable without causing practical problem

Δ: Variation nearly allowable

x: Unallowable variation causing a practical problem.

Resolution Power

The resolution power was evaluated based on a magnified image sample observed using a microscope.

Criteria of assessment of the resolution power were as follows:

⊙: No problem

◯: Slight reduction but acceptable,

Δ: Reduction beyond acceptable level,

x: Blur image causing practical problem

As seen in Table 5, the photoreceptor of this embodiment retains stable photoreceptor characteristics even when used repeatedly for a long time and has a small variation within Job and produces blur-free images after repeated use.

On the other hand, when the compound of the formula 2 is not contained as in Comparative Example 1, an image blur is hard to occur owing to the effect of the compound of the formula 1, but a variation within Job is large. When the compound of the formula 1 is not contained as in Comparative Example 2, an image blur occurs. In addition, a variation within Job is large. This is considered to be because the charge transport material itself is degraded by an oxidative gas or the like.

When a compound other than the compound of the formula 2 is used as in Comparative Examples 3 to 5, an image blur is suppressed, but a variation within Job is large. This is considered to be because in these combinations, the interaction with the compound of the formula 1 is weak, so that degradation of the compound of the formula 1 cannot be suppressed.

Thus, in this embodiment, there can be provided a photoreceptor in which an image blur does not occur and a variation within Job is suppressed even when the photoreceptor is used repeatedly for a long time, so that high-quality images can be stably obtained over a long period of time.

By using the photoreceptor of this embodiment, an image forming method, an image forming apparatus and a process cartridge for an image forming apparatus, which are capable of outputting images that have a small change in image density and color and are excellent in image quality.

According to the present invention, a photoreceptor is provided which has excellent electrostatic characteristics to reduce the image density unevenness and image blur.

Having now fully described embodiments of the present invention, it will be apparent to one of ordinary skill in the art that many changes and modifications can be made thereto without departing from the spirit and scope of embodiments of the invention as set forth herein.

What is claimed is:

1. A photoreceptor comprising:
an electroconductive substrate; and
a laminate structure formed of at least a charge generating layer and a charge transport layer and provided overlying the electroconductive substrate,
wherein the charge transport layer comprises a charge transport material, a compound represented by the following formula 1 and a compound represented by the following formula 2: 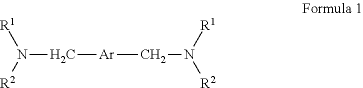
in the formula 1, R¹ and R² each independently represent substituted or non-substituted alkyl groups or aromatic hydrocarbon groups and one of R¹ and R² represents a substituted or non-substituted aromatic hydrocarbon group, R¹ and R² bonded to the same nitrogen atom may be bonded together to form a substituted or non-substituted nitrogen-containing heterocyclic group, and Ar represents a substituted or non-substituted hydrocarbon group; 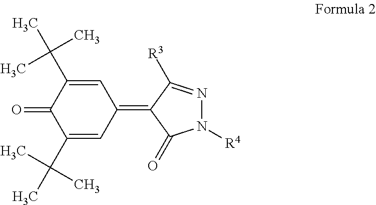
in the formula 2, R³ and R⁴ each independently represent substituted or non-substituted alkyl groups or aromatic hydrocarbon groups.

2. The photoreceptor according to claim 1, further comprising a surface layer provided overlying the charge transport layer.

3. The photoreceptor according to claim 2, wherein the surface layer is a surface layer formed by curing a radical polymerizable compound which has a charge transport structure and a radical polymerizable compound which has no charge transport structure.

4. The photoreceptor according to claim 2, wherein the surface layer comprises a filler.

5. An image forming apparatus comprising:
the photoreceptor of claim 1 to bear a latent electrostatic image thereon;
a charging device to charge a surface of the photoreceptor of claim 1,
an exposure device to irradiate the surface of the photoreceptor of claim 1 to form the latent electrostatic thereon;
a development device to develop the latent electrostatic image with toner to obtain a toner image;
a transfer device to transfer the toner image to a recording medium; and
a cleaning device to remove toner remaining on the surface of the photoreceptor of claim 1.

6. A process cartridge comprising:
the photoreceptor of claim 1, and
at least one device selected from the group consisting of a charging device, a development device, a transfer device, a cleaning device, and a discharging device,
wherein the process cartridge is detachably attachable to an image forming apparatus.

7. An image forming method comprising:
charging a surface of the photoreceptor of claim 1;
exposing the surface of the photoreceptor of claim 1 with light to form a latent electrostatic image thereon;
developing the latent electrostatic image with toner to obtain a toner image;
transferring the toner image to a recording medium; and
cleaning the surface of the photoreceptor of claim 1 to remove the toner remaining thereon.
